(19) United States
(12) Patent Application Publication
(10) Pub. No.: US 2019/0108220 A1
(43) Pub. Date: Apr. 11, 2019

(54) METHOD OF DATA STORAGE AND LANGUAGE CONVERSION

(71) Applicant: Nguyen Duy Thang, (US)

(72) Inventor: Nguyen Duy Thang, (US)

(21) Appl. No.: 15/506,756

(22) PCT Filed: Aug. 28, 2015
(86) PCT No.: PCT/VN2015/000011

§ 371 Date: Feb. 27, 2017

(30) Foreign Application Priority Data
Aug. 28, 2014 (VN) 1-2014-02899

(51) Int. Cl. G06F 17/28; G06F 16/901

(52) U.S. Cl. CPC G06F 17/289; G06F 16/901

(57) ABSTRACT

The invention has proposed multipurpose language data storage method with the aim at making machine translation, text storage and processing better.

This method includes the following steps:
Creating data structure, dividing data areas to store components including part of speech, vocabulary, general grammar, synonyms and expansion; word, phrase, sentence, character . . . are stored by a value. It can be understood that this invention stores data according to object (language unit) but not character at present. Synonyms may be represented by a common value. For all languages, a language unit (word, phrase, sentence . . . ) will have only one value.
Converting plain text into data form included in the invention. It is necessary to determine input language, part of speech, grammar, vocabulary . . . to convert it into data corresponding to 8 first bytes of data areas used to determine which language to be stored.
Converting data of the invention into text or other forms such as sounds, images and signs . . . . The first steps is to see whether the language to be stored, the language to make data and the result language are identical. In case of two languages, it is required to assign values of Synonyms and Expansion again in default. After that, data is taken simply by converting stored data of the invention into values in the memory including result data.

### MENTIONED TECHNIQUE FIELD

Method of data storage and language conversion is applied in techniques of machine translation, IT-based text storage and search

### TECHNICAL CONDITION OF THE INVENTION

Text has currently been stored by storing value corresponding with its letter in code character code. It means that storage is based on the character code. Unicode has widely been used but it also includes various kinds. For example in Vietnamese language, Unicode includes decomposed Unicode and composed Unicode. Independence of code is very useful to search information and do machine translation.

To store a word (a unit of language), we shall use a set of values corresponding with values included in the code. The set of these values has indefinite length and it usually takes more than 4 bytes to store.

During text search (information), speed and quality of search depends on length of the text to be searched, the size of the database and the type of data encoding. If there is any method to reduce database size and make data independent with the code, quality of text search will be better than the present.

There are three methods of machine translation including: Statistical machine translation (mainly current method), Example-based machine translation and Rule-based machine translation. Despite of different translation technique, translation quality is affected by number of synonyms. With current storage method, the synonyms have no relationship with each other, they are considered as independent cases during translation. For example, to indicate a species of soybean, there are three ways of spelling including “ [symbol] tu'o'ng”, “ [symbol] tu'o'ng” and “ [symbol] nành” in Vietnamese and two ways of spelling including “soya’ and “soya bean” in English. It requires 6 (3*2) cases to completely scan two those data domains. The part of speech and vocabulary cannot be simultaneously stored with the current storage method, so it takes more steps to determine the part of speech.

With current storage method, the result obtained from storage of a unit of language will vary depending on different languages. As an example of above species of soybean, the storage result of “ [symbol] tu'o'ng” and “soya” is different although both of them indicate a specific thing.

### TECHNICAL NATURE OF THE INVENTION

The invention aims at providing a data storage method used for all languages (mostly text, it can be extended to other types of information), this method makes storage, information search and machine translation more efficient. To achieve this purpose the invention provides a way to store vocabulary (language unit) and the grammatical characteristics of natural language in variables with the length of 4 bytes. That is, each language unit corresponds to a value of variable with the length of 4 bytes. That variable is divided into different sections for grammar, vocabulary separately and for all languages in common, and section for each specific language.

This method includes three steps:
Creating data structures (division of data areas)
Converting plain text or other forms of information in the form of data specified in the invention
Converting the data specified in the invention into text or other formats.

### BRIEF DESCRIPTION OF THE DRAWINGS

FIG. 1 in the document explain the data structure used in the invention.

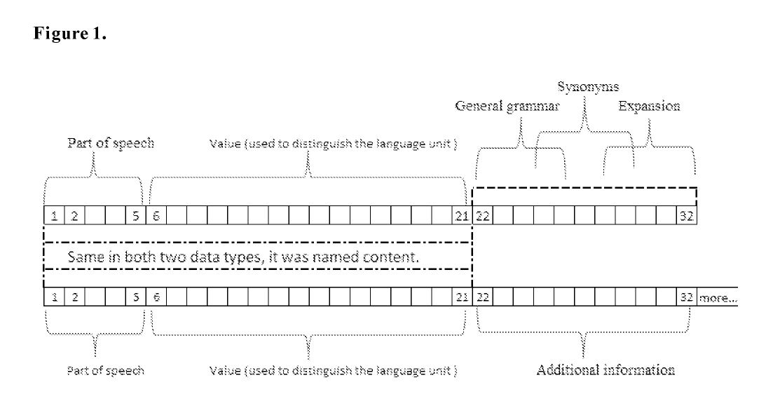

### DETAILED DESCRIPTION OF THE INVENTION

Step 1: Setting up data structure, separating areas within data domain of 32 bit in order to simultaneously store vocabulary and par of speech (grammar). Data stored in the form of above structure is called DLSC. Used parts of speech are nouns, verbs, adjectives, adverbs, conjunctions, prepositions, pronouns, interjections, articles, special characters and parts of speech (to determine elements such as phrases and sentences).

Each value of DLSC may correspond with a word, a phrase or even a complete sentence of natural language.

Database includes two types of values with basic length of 04 bytes (4 byte=32 bit=2³² value that can be extended to 64 bits or more)
Data of type 1: divided into 2 parts including Content (21 bits)+Grammar (11 bits) The content includes 2 sub-parts including Part of speech (5 bits) and Value (16 bits). The grammar includes three sub-parts including General grammar, Synonyms and Expansion.
General grammar: storing grammatical information of most general language unit of all languages
Synonyms: used to distinguish all synonyms. This is a way of giving all synonyms to the only form. Number of supported synonyms may vary depending on change in Part of speech and Expansion.
Expansion: used to add grammatical elements to each specific language
Data of type 2: divided into 2 parts including Content (21 bits)+Additional information (11 bits).

The content includes 2 sub-parts including Part of speech (5 bits) and Value (16 bits) Additional information: used for storage and may be used to support translation

The element of Content in both above types has the same value and corresponds with a unit of natural language (value of this element will be constant for different natural languages. It acts a connection bridge among languages and between two types of data included in the database). Data of type 2 may be expanded to 64 bits, 128 bits or more (variables) because it is necessary to store much information during translation. However, 21 first bits of this data area shall be identical to 21 first bits of data of type 1.

Component distribution in the value domain of 4 bytes (position of variable areas may vary)

Part of speech is stored from bit 1 to bit 5 with 32 values. (Part of speech influences Value and Grammar)

Value is stored from bit 6 to bit 21 with 65536 values. Grammar is stored from bit 22 to bit 32 with 2¹¹ values. (Content=Part of speech+Value=2²¹) If Part of speech has value of 0, main value area is Unicode table (may be combined with Grammar part to create codes which are larger than Unicode, determine natural language in which stored language originates)

If Part of speech has value of 1, each value of value area will correspond with an adverb.

If Part of speech has value of 2, each value of value area will correspond with an adjective.

If Part of speech has value of 3, 4, 5, each value of value area will correspond with a noun of animals.

If Part of speech has value of 8, 9, each value of value area will correspond with a noun of plant.

If Part of speech has value of 12, 13, each value of value area will correspond with a noun of objects.

If Part of speech has value within the range of 16, 17 each value of value area will correspond with a noun of fact, phenomenon . . . .

If Part of speech has value of 20, each value of value area will correspond with a verb.

If Part of speech has value within the range of 21 each value of value area will correspond with a conjunctions, prepositions, pronouns, interjection, article.

If Part of speech has value of 22, each value of value area will correspond with an idiom.

If Part of speech has value within the range of 23 and 24 each value of value area will correspond with sentence.

Used to spend, if Part of speech has value of 6, 7, 10, 11, 14, 15, 18, 19 and 25 to 31. Value of Part of speech also influences component of Grammar.

If Part of speech has value of within the range of 1 and 2, Grammar area will include three sub-parts:

The part of General Grammar enables to determine kinds of comparison (superlative, comparative, Equality comparison, and infinitive form, Comparative of inferiority and Superlative of inferiority) If Part of speech has value of 3, 4, 5, 8, 9, 12, 13, 16, 17 Grammar will be divided into three following sub-parts: The part of General Grammar enables to determine forms and genders of noun (singular, plural, masculine, feminine, neutral gender, infinitives). Determination of manner in some languages such as Russian is added in the expansion.manner (2³ value). English includes countable and uncountable nouns, so expansion part will be Expansion.countability 2¹.

If Part of speech has value of 20, Grammar will be divided into three following sub-parts:

The part of General Grammar enables to determine tense of verb (past, present, future and infinitive). With a specific language, number of Synonyms and Expansion will be changed. For example, as for Vietnamese, Synonym2⁵+Expansion2³ but as for English, two those values are changed to Synonym2²+Expansion2⁷ since Expansion2⁷=Expansion2⁴+Expansion.Person2³. In Vietnamese, conjugation of verb is not dependent on the Person and Form and only includes three simple tenses, so Expansion is not needed to add grammatical elements. In contrast, English is different and conjugation of verb is more complex, so it requires expansion to absolutely conjugate tenses, distinguish Person and Form of subject on which verb depends.

If Part of speech has value of within the range of 21 and 24, Grammar area will include two sub-parts:

Two first values of data area including values used in the invention are those which are used to determine source language forming that data. 4 byte has value of 0 (check), 4 second bytes are used to determine language (set up based on value of national code, Vietnam=84)

Step 2: Converting text into DLSC. Determining language used to store. Using current search algorithms (such as branch, nodes . . . ) to convert (determine vocabulary, part of speech, general grammar and additional information).

Characters which are not vocabulary are included in the variables as vocabulary as usual.

Step 3: Converting value of DLSC into text or other forms such as sounds and images . . . . Since DLSC is value and structural, it is difficult to do this conversion. There are only a few notes during conversion. Grammatical elements which vary DLSC via languages may be different values. It depends on natural language which creates those basic values. There are two cases happening during data processing: (reading 8 first bytes of data area to determine)

If DLSC is created from the language in accordance with the language to be processed (in case language A has mapping to DLSC and this DLSC has mapping to language A), Synonyms and Expansion are completely used so that the process may be exactly restored (complete recovery).

If DLSC is created from the language different from the language to be processed (in case language B has mapping to DLSC and this DLSC has mapping to language A—that works as a process of translating from language B into the language of A), components of Synonyms and Expansion are not used. Two those values will be replaced with values of the language to be processed (language A) (incomplete recovery). For example, value of DLSC is created from word “soya”, it will be processed as “soya” in Vietnamese and stored in the form of Part of speech=3, Value=3; Npc.form=0; Npc.gender=0; Synonym=0; Npc.count=0; =>Values which will be used are: Part of speech=3; Value=3; Npc.form=0; Values including Npc.gender and Synonyn have default value of 0 that enables to determine the word ““ [symbol] tu'o'ng”. We can use exploratory variable to scan all synonyms. For example, if we consider Synonym=1, received word is “ [symbol] tu'o'ng” . . . (If inputted value of Synonym is more than number of actual synonyms, it will give back to the first word).

For example of using database structure:

Storing nouns of “ [symbol] tu'o'ng, [symbol] tu'o'ng, [symbol] nành” in Vietnamese (3 synonyms) is as follow:

Word “ [symbol] tu'o'ng” is stored with Part of speech=Value=3, Npc.form=Npc.gender=0, Synonym=0. Word “ [symbol] tu'o'ng” is stored with Part of speech=Value=3, Npc.form=Npc.gender=0, Synonym=1. Word “ [symbol] nành” is stored with Part of speech=Value=3, Npc.form=Npc.gender=0, Synonym=2. Respectfully words “soya” and “soya bean” in English (2 synonyms). Values of components are: Word “soya” is stored with Part of speech=Value=3, Npc.form=Npc.gender=0, Synonym=0; Npc.count=0.

Word “soya bean” is stored with Part of speech=Value=3, Npc.form=Npc.gender=0, Synonym=1; Npc.count=0.

Therefore, to determine species of soybean in pair of Vietnamese-English (or any language), we only consider two areas of Part of speech=Value=3. Vale of Synonym area is important for each specific language. Exterminate synonym.

How to store the verb “run” in the context: He runs too fast [symbol] ord “ch [symbol] y” (infinitive) is stored with Part of speech=20, Value=9, Npc.tense=3, Synonym=0. Word “ran” is stored with Part of speech=20, Value=9, Npc.tense=0, Synonym=0.

In English: he had been running too fast. Values of components will be as follow: Phrase“had been running” is stored with Part of speech=20, Value=9, Npc.tense=0, Synonym=0, Expansion.tense=0, Expansion.gender and form=3.

### Achieved Efficiency

Synonyms may be represented by the only value. Simultaneous storage of grammar and vocabulary makes translation become easier.
During storage with a language unit (object), we only have a value for all languages ( [symbol] tu'o'ng, soya . . . have value of Part of speech=Value=3.)
For any natural language, DLSC may have mapping to each other under rate 1:1. It means that DLSC may be completely similar to any natural language (complete recovery of data after being stored by multipurpose language data storage method) The invention does not store vocabulary in the form of character. The vocabulary is determined by the only value, so it is completely independent with code that is very useful to translate and seek for information.
Because a value of DLSC may correspond with a word, a phrase or even a complete sentence of natural language, storage space will be decreased so much and search speed will be 10 time faster.
The invention has created a connection between vocabulary and other forms of information (sound, image).

The invention makes it easy to switch between languages.

1. Method of data storage and language conversion: Unlike normal translation methods, this method does not store language units (word, phrase, sentence . . . ) in the form of character but in the form of the only value (storage according to object). This method may simultaneously store part of speech (grammar) and vocabulary. For all languages, a given language unit has only one value when storage. Synonyms are also determined by a common value. Vocabulary may be connected with other forms of information (sounds, images . . . ). This method includes the following steps:
a (Creating data structure-Dividing data areas) 32-bit data area is divided into parts (may be expanded into 64-bit, 128-bit or more data areas) under regulation: part of speech (5 bits), Value (16 bits), Grammar (11 bits), the grammar part is divided into three sub-parts including General grammar, Synonyms, Expansion with variable size in accordance with value of Part of speech, Value and Part of speech used to determine a specific language unit (sentence, phrase, word . . . ), when expanding data area, position and size of Part of speech and Value shall be unchanged,
b (Converting plain text into the data form of the invention) Determining language of text, language unit (sentence, phrase, word . . . ), part of speech, synonym, grammar, additional information in order to convert them into data of the invention,
c (Converting data of the invention into text or other forms): Determining whether the language which creates data and the result language are identical; in case of two languages, it is required to assign values of Synonyms and Expansion again in default, changing stored values of the invention to values of memory including result data with the aim at taking the result, making machine translation, text storage and search more efficient.
